(19) United States
(12) Patent Application Publication
(10) Pub. No.: US 2011/0054731 A1
(43) Pub. Date: Mar. 3, 2011

(54) SYSTEM AND METHOD FOR BI-DIRECTIONAL WIRELESS INFORMATION TRANSFER

(76) Inventors: Lynn Ann DeRose, Gloversville, NY (US); Joseph James Salvo, Schenectady, NY (US); Robert August Graziano, Niskayuna, NY (US); John William Carbone, Niskayuna, NY (US); Brandon Stephen Good, Brainard, NY (US); Roman Brusilovsky, Clifton Park, NY (US); Andrew John Calver, Marina del Rey, CA (US); Douglas Roy Forman, Ballston Lake, NY (US); Scott Charles Evans, Burnt Hills, NY (US)

(21) Appl. No.: 12/550,457

(22) Filed: Aug. 31, 2009

(51) Int. Cl. G06F 19/00

(52) U.S. Cl. 701/33

(57) ABSTRACT

A system and method a bi-directional wireless information system includes a plurality of sensor nodes spaced along a path of travel of an object, each of the sensor nodes corresponding to a specified location along the path of travel. The system also includes a transceiver associated with the object, the transceiver configured to communicate with the plurality of sensor nodes, such that a location of the object is determinable based on wireless communication between the transceiver and the plurality of sensor nodes. A central database included in the system is configured to receive the location of the object from at least one of the transceiver and the plurality of sensor nodes, receive object-specific data from at least one of the transceiver and the plurality of sensor nodes, and transmit location-specific data to the transceiver.

### BACKGROUND OF THE INVENTION

Embodiments of the invention relate generally to a system and method for bi-directional wireless information transfer and, more particularly, to a system and method for self-powered bi-directional wireless information transfer and information sharing within a global network of discrete objects for optimizing and tracking movement of objects.

Maintaining an accurate system for tracking the movement of objects has long been an area of focus for streamlining and optimizing various processes. For example, the study of traffic patterns of vehicles and people have been used to minimize traffic jams and long lines. Likewise, the location of inventories and/or assets at each step of a supply chain process have been monitored to stream and optimize these processes. One technique for enhancing efficiency of the supply chain process involves placement of unique computer-readable identification codes, e.g., bar codes on the inventories. By scanning these at various checkpoints during delivery, a record of the inventories may be maintained. Unfortunately, this process requires the affirmative step of locating and scanning each identification code in a timely manner. Further, these techniques lead to unnecessary delay in the supply chain process and provide no information transfer between checkpoints.

Current tracking systems employing global positioning systems (GPS), radio frequency identification (RFID) and/or other similar technologies have greatly helped in streamlining and optimizing the supply chain processes. Typically, RFID readers are installed at the entrances and exits of supply chain entities, allowing one to track in real-time where the inventories are in the supply chain, in the manufacturing facility, or in the distribution center or in the retail store. Similarly, GPS based tracking system may be employed to track the assets such as trailer, rail cars, shipping or cargo containers, and the like during transit. Thus, these systems enable monitoring and management of various inventories and/or the assets.

However, existing monitoring techniques fail to provide bi-directional information transfer during transit. For example, once an inventory tagged with RFID leaves the manufacturing facility and is loaded into the trailer, the tagged inventory cannot be tracked. This is particularly important as more and more companies are relying on trailers or mobile assets to act as a mobile warehouse for them. Thus, there is a need to get real-time information of where the inventories and/or assets are at any point in time. Likewise, current on-vehicle GPS systems and PDA devices are not integrated into a global network for bi-directional location-specific data sharing.

Further, existing data transfer techniques rely on external power sources to move information over large distances. As such, these data transfer systems incorporating known techniques may experience downtime during power outages, leading to loss of global communication and networking capability when information transfer is most needed (e.g., during an attack on homeland security, tornado, hurricane, etc.). Thus, a need exists for a system and method capable of self-powered bi-directional wireless information transfer.

It is therefore desirable to provide a wireless communication system for data transfer and information sharing within a global network of discrete objects for optimizing movement of objects in an efficient fashion. Additionally, it is desirable to provide a robust information transfer system for relaying both location-specific and object-specific data without relying on external power sources.

### BRIEF DESCRIPTION OF THE INVENTION

Embodiments of the invention provide a system and method for bi-directional wireless information transfer.

Therefore, in accordance with one aspect of the invention, a bi-directional wireless information system includes a plurality of sensor nodes spaced along a path of travel of an object, each of the sensor nodes corresponding to a specified location along the path of travel. The system also includes a transceiver associated with the object, the transceiver configured to communicate with the plurality of sensor nodes, such that a location of the object is determinable based on wireless communication between the transceiver and the plurality of sensor nodes. A central database included in the system is configured to receive the location of the object from at least one of the transceiver and the plurality of sensor nodes, receive object-specific data from at least one of the transceiver and the plurality of sensor nodes, and transmit location-specific data to the transceiver.

In accordance with another aspect of the invention, a method for bi-directional wireless transmission of information between an object and a central data system includes the steps of arranging a network of wireless sensors along a pathway and associating each sensor of the network of wireless sensors with a respective position along the pathway. The method also includes the steps of wirelessly transmitting an object location to a central data system when the object moves along the pathway, the object location corresponding to the respective positions of the wireless sensors, accessing location-specific data from the central data system, the location-specific data corresponding to the object location, and wirelessly transmitting the location-specific data from the central data system to the object.

In accordance with another aspect of the invention, a wireless roadway information system includes a network of sensors positioned along a roadway, each of the sensors corresponding to a specified location. The system also includes a processing unit disposed within a vehicle and comprising a transceiver configured to wirelessly communicate with the network of sensors, such that a location of the vehicle is determinable based on wireless communication between the transceiver and one of the network of sensors and a plurality of vehicle data sensors configured to acquire vehicle-specific information. The system also includes a central database located remotely from the network of sensors and the transceiver. The central database is configured to receive a wireless signal from one of the transceiver and a sensor in the network of sensors, the wireless signal including a location of the vehicle and vehicle-specific information, determine location-specific information based on the location of the vehicle, determine vehicle control commands based on the vehicle-specific information, and transmit the location-specific information and vehicle control commands to the transceiver.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a schematic diagram of a wireless information system according to an embodiment of the invention.

FIG. 2 is a schematic diagram of a wireless information system according to an embodiment of the invention.

FIG. 3 is a schematic diagram of a wireless information system according to an embodiment of the invention.

FIG. 4 is a schematic diagram of a wireless information system according to an embodiment of the invention.

FIG. 5 is a schematic diagram of a vehicle for use with a wireless information system according to an embodiment of the invention.

FIG. 6 is a schematic diagram of a fleet vehicle for use with a wireless information system according to an embodiment of the invention.

### DETAILED DESCRIPTION

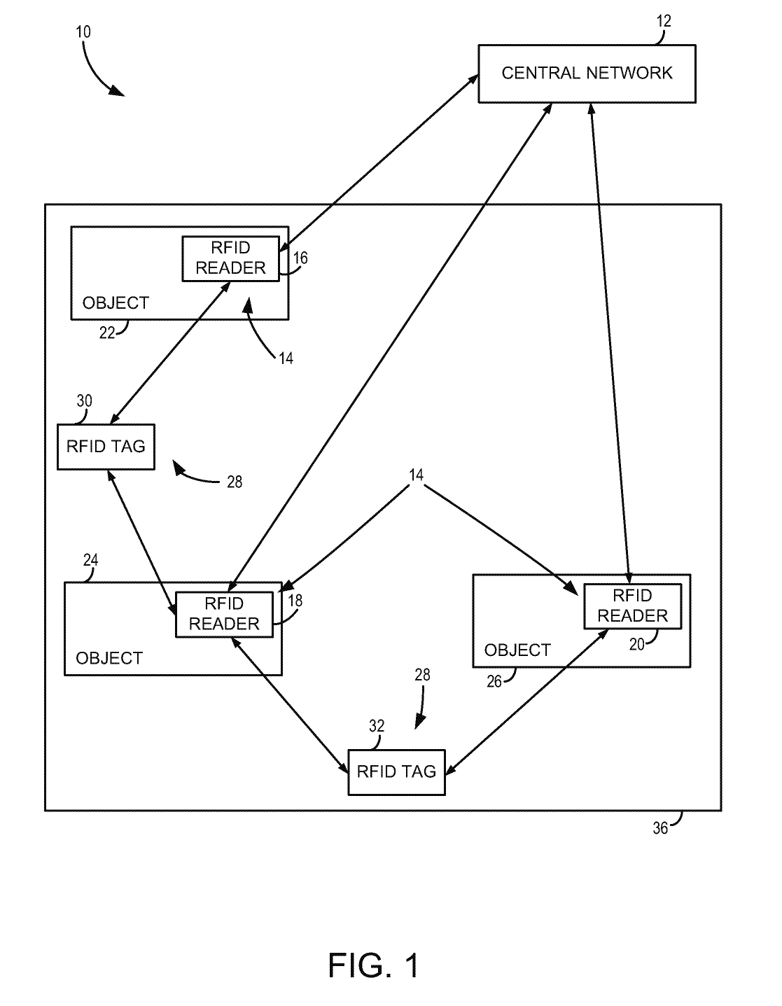

Referring to FIG. 1, a schematic diagram of an exemplary wireless information system 10 is illustrated in accordance with aspects of the present invention. The information system 10 includes a central network or central database 12 for monitoring and/or information sharing via a network 14 of readers 16, 18, 20 associated with objects 22, 24, 26. According to aspects of the present invention, objects 22-26 may include transit vehicles (e.g., cars, trucks, and planes), human beings, and handheld wireless devices (e.g., PDAs and cellular phones). System 10 is configured to relay location-specific information and object-specific information between central network 12 and objects 22-26. As used herein, location-specific information includes information and data related to a specific location, such as, for example, weather information, traffic information, emergency alerts, road conditions, geographic data, nearby services, and the like. Object-specific information, as used herein, includes information and data related to a specific object, such as, for example, engine conditions and diagnostics, driver information, inventory data, and the like.

Wireless information system 10 also includes a sensor network 28 of wireless sensors 30, 32, such as, for example, IR sensors, RFID tags, eSensors, i-Bean® devices, or wireless access points. Sensor network 28 and reader network 14 are configured to communicate with central network 12 over a wireless communication network (e.g., Bluetooth®, Zigbee®, Synaps Wireless®, G2, and the like). Sensor network 28 may be powered via solar sensors or a battery power source. Alternatively, sensor network 28 may be hardwired to a dedicated power supply.

Sensor network 28 may comprise a multi-hop wireless network configured to minimize energy costs using a connectionless scheduling protocol, such as the wireless sensor network disclosed in Energy Minimization in Wireless Sensor Networks through a Connectionless Scheduling Protocol, IEEE MILCOM 2005, Oct. 17-20, 2005, ISBN 0-7803-9393-7. In such a sensor network, only intended wireless sensors (i.e., receivers) are powered up when an intended transmission is sent, as opposed to an inherently broadcast wireless network. A pre-defined global schedule may be configured for both scheduled sensor on-times (targeted for one-to-one transmissions from any sensor within range to intended receivers) and scheduled transmissions (designed for one-to-many transmission of messages of interest to multiple sensors). These schedules are determined by each sensor using an algorithm based on global time and a distinguishing factor, such as, for example, GPS position or a unique sensor identifier.

According to one embodiment of the present invention, network 14 may be configured along a pathway or throughout a site 36, such as an amusement park, airport, parking lot, or other high-traffic site. Sensors 30, 32 may be configured to relay location information a respective reader 16-20 when objects 22-26 come into range, allowing wireless information system 10 to establish the presence and location of objects 22-26 within the site. Based on the location of objects 22-26, central network 12 may transmit location information to respective reader 16-20 regarding nearby site resources, for example, nearby restaurants or other points of interest. Location information of objects 22-26 may also be used for queue optimization by monitoring the number of people in a line and directing people to a different line via messages sent to respective reader 16-20 to optimize traffic flow. Also, location information of objects 22-26 may be analyzed by central network 12 to monitor traffic and use patterns for marketing purposes and for scheduling equipment maintenance.

Additionally, sensors 30, 32 may be configured to relay parking location information of a vehicle within a parking lot to a handheld PDA or cellular phone. Alternatively, sensors 30, 32 may be configured to monitor the number of vehicles entering and exiting a parking lot and relay the number of empty parking spots in a parking lot to a driver en route to the parking lot via a handheld PDA or cellular phone.

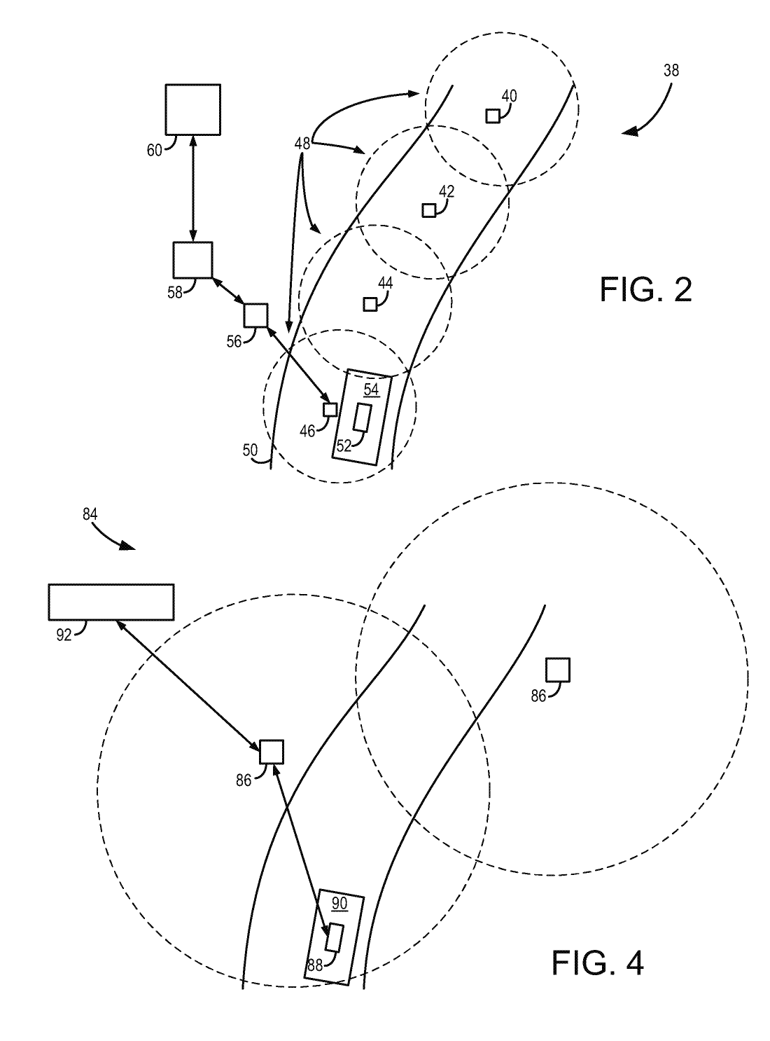

Referring now to FIG. 2, the wireless information system described with respect to FIG. 1, may be configured as a continuous coverage wireless road system 38, according to one embodiment. System 38 includes individual wireless access points 40, 42, 44, 46 of a wireless network 48, which may be positioned along a roadway 50. Access points 40-46 interact with a wireless bridge 52 located on a vehicle 54, allowing system 38 to establish and monitor a location of vehicle 54 along roadway 50. Location information of vehicle 54 is transmitted via a router 56 to a satellite or hard line 58, which relays the information to a central network 60.

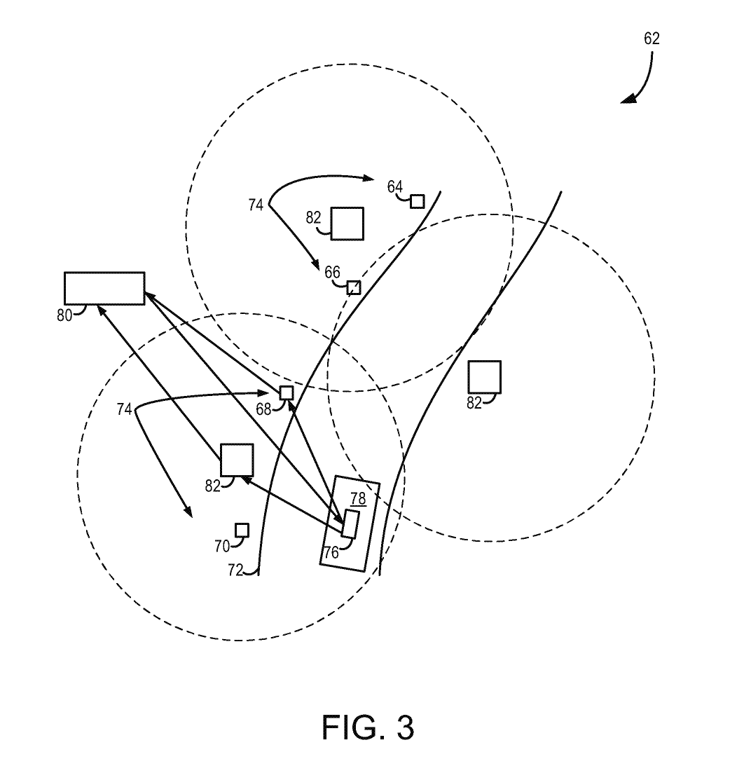

Alternatively, as shown in FIG. 3, a wireless road system 62 may include a number of RFID identifiers or tags 64, 66, 68, 70 positioned along a roadway 72 to form a wireless multi-hop network 74. An RFID reader 76 may be located in a vehicle 78 to pick up the tag number of a RFID tag 64-70 as vehicle 78 passes tag 64-70 on roadway 72. Reader 76 sends the tag number via network 74 to a central system 80, which looks up the location of tag 64-70 and sends back pertinent information about that location to vehicle 78. Alternatively, optional cellular towers 82 may be used to relay signals between RFID tags 64-70 and central system 80.

Referring now to FIG. 4, a wireless road system 84 is illustrated according to another aspect of the present invention. System 84 utilizes existing cellular towers 86 to form a wireless network. A cellular transmitter 88 located in a vehicle 90 relays information between vehicle 90 and a central network 92 via cellular towers 86 using existing cellular protocols.

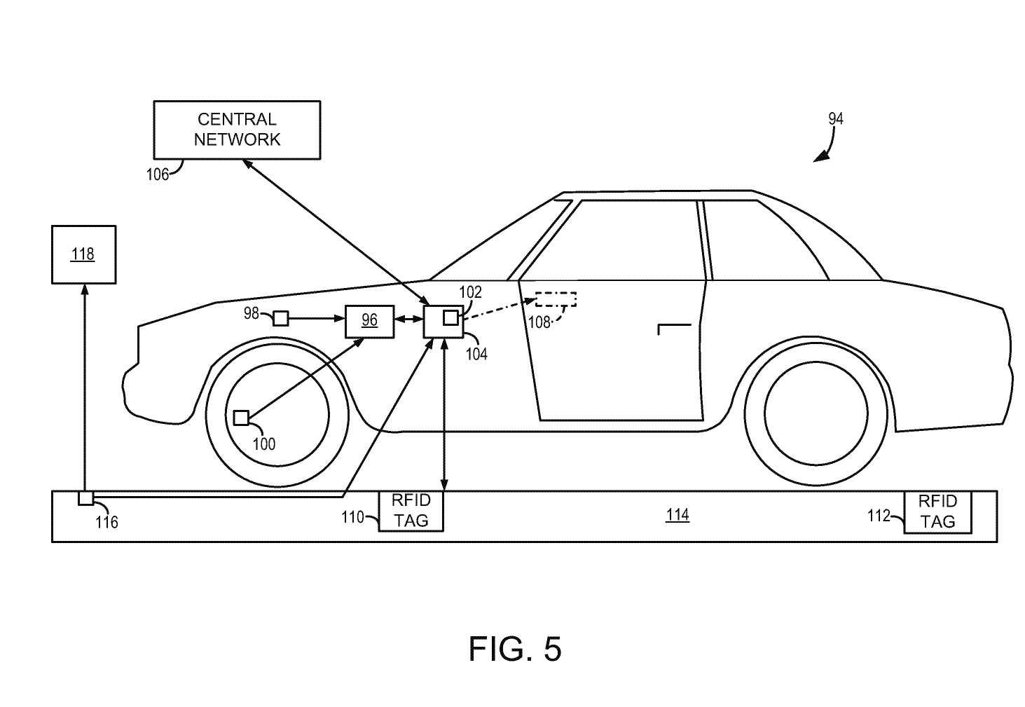

FIG. 5 illustrates a schematic of a vehicle 94 configured for use with embodiments of the present invention. Vehicle 94 includes a processing unit 96 or ‘black box’ that monitors diagnostics of vehicle 94 via a number of sensors 98, 100 located throughout vehicle 94. Monitored diagnostics may include general car status, odometer readings, fluid levels, battery level, tire pressure, and the like. Processing unit 96 communicates with a wireless bridge or reader 102 associated with a computer interface 104 to send object or vehicle information regarding the monitored diagnostics to a central network 106. Processing unit 96 may be configured to transmit information to an optional PDA or laptop computer 108 (shown in phantom) located within vehicle 94.

Reader 102 also receives location information from position sensing devices 110, 112, such as RFID tags or wireless connection points located along a roadway 114 as described with respect to FIGS. 2 and 3. Reader 102 transmits the location information from position sensing devices 110, 112 and object or vehicle information from processing unit 96 to central network 106. Alternatively, reader 102 may be configured as a cellular transmitter to communicate with central network 106 via a network of cellular towers, as described with respect to FIG. 4. Central network 106 analyzes the location and object information and transmits a response to vehicle 94. The response may include location-related information specific to the determined location of vehicle 94, such as weather conditions, traffic conditions, traffic detours (i.e., alternate travel routes), upcoming road construction, and news, sports and stock updates, for example.

Central network 106 may also receive signals from a roadway sensor 116 configured to monitor road conditions. For example, roadway sensor 116 may be a black ice sensor embedded in roadway 114 and constructed to detect a surface temperature of roadway 114. Sensor 116 may transmit a temperature signal to central network 106 via reader 102 or an auxiliary station or access point 118 located along roadway 114. Based on the received temperature signal and the location of vehicle 94, central network 106 may carry out an algorithm to determine if a potential black ice or dangerous road condition exists for vehicle 94. If so, central network 106 may transmit a signal to processing unit 96 to automatically cause vehicle 94 to enter a preventative anti-skid mode, for example. Alternatively, central network 106 may transmit a warning signal to vehicle 94 to alert a driver of the upcoming potentially dangerous road conditions. It should be noted that, in certain embodiments, auxiliary station 118 may include a processor for processing or analyzing the response received from position sensing devices 110, 112 and/or sensor 116 and perform data processing functions so not all of the acquired data need be sent to central network 106 over the wireless communication network.

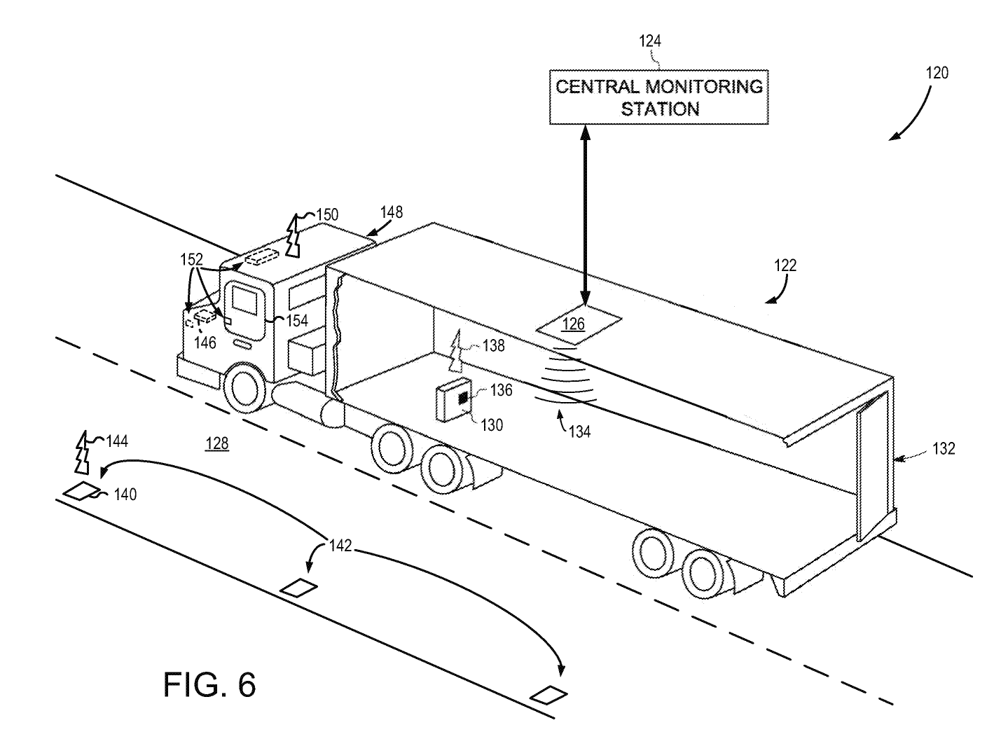

FIG. 6 illustrates a schematic of a wireless communication system 120 for use with a fleet vehicle 122 for exchange of location and object information relevant to fleet vehicle 122, in accordance with aspects of the present invention. System 120 includes a central monitoring station or central network 124 in communication with a network of wireless readers, such as RFID reader 126. Central station 124 may request (activate/initiate) RFID reader 126 to locate vehicle 122 along a roadway 128 or to determine object information regarding an inventory 130 within a trailer 132 of vehicle 122. Upon receiving the request, RFID reader 126 activates for a specified period of time (e.g., for 1 second or for 1.3 seconds) via an activation signal and emits radio frequency (rf) signals 134. An RFID tag 136 located on inventory 130 receives rf signal 134 and responds back with rf signal 138 comprising its unique identification code. Additionally, a RFID tag 140 of a network of RFID tags 142 located along roadway 128 within range of RFID reader 126 may receive rf signal 134 and respond back with rf signal 144 comprising its unique identification code.

RFID reader 126 receives signals 138, 144 and relays the response data (RFID data) to central station 124 over a wireless or satellite communication network. Central station 124 may then analyze the response to determine the presence and location of RFID tags 136, 140. Additionally, monitoring station 124 may provide a visual display of inventory location and identification within trailer 132. Thus, end users can check in real time the location of their inventories that are tagged with RFID tags.

Wireless communication system 120 also includes a processing unit 146 mounted within a cab 148 of fleet vehicle 122. Similar to processing unit 96 of FIG. 5, processing unit 146 may be configured to monitor object information associated with fleet vehicle 122 and communicate with RFID reader 126 via a wireless signal 150. Processing unit 146 receives object information or data from a network of wired or wireless sensors 152 located on or within cab 148. Sensors 152 may be configured to monitor vehicle diagnostic information, including engine status, odometer readings, fluid levels, battery level, tire pressure, and the like.

Sensors 152 may also be configured to monitor an open/closed status of a door 154 of cab 148. A signal from sensors 152 related to the open/closed status may be transmitted to monitoring station 124 along with location information from RFID tag 140 so that monitoring station 124 may determine the location where door 154 was opened. Sensors 152 may also be used for security purposes to determine who opened or closed door 154 by analyzing fingerprint data using a biometric sensor or reading a badge on a driver's uniform using an RFID or optical sensor, for example. Sensors 152 also may be configured to send an alert to monitoring station 124 if no badge is sensed or if an unknown fingerprint is read.

Also, sensors 152 located within cab 148 may be biometric sensors configured to monitor various physical conditions of a driver and acquire biometric object data. For example, biometric sensors may be configured to monitor a driver's eyes after a lengthy period of driving (to determine how focused they are, for example), sweat glands on a driver's hands or a driver's heart rate or blood pressure (to determine if a driver is driving too aggressively, for example). Monitoring station 124 analyzes and the biometric object data received from sensors 152 in combination with the location information received from RFID tag 140 to determine if a warning signal should be sent to the driver. For example, if monitoring station 124 determines that the driver's eyes are not focusing very well or that the driver is getting tired, monitoring station 124 may suggest that the driver pull of the road at a nearby rest stop. Alternatively, monitoring station 124 may send a signal to a GPS (not shown) located in cab 148 to check for nearby company-sponsored hotels or nearby restaurants that the driver prefers.

Sensors 152 positioned on an external surface of fleet vehicle 122 may be configured to monitor for traffic congestion or traffic accidents using a camera or motion sensor, for example. When traffic problems are sensed, information regarding the traffic conditions together with location information received from RFID tag 140 is relayed to monitoring station 124. Monitoring station 124 transmits information regarding the traffic conditions to other vehicles approaching the current location of fleet vehicle 122, or, alternatively, to a local radio or television station for broadcasting.

As will be appreciated by those skilled in the art, the capabilities described above with respect to sensors 152 also may be implemented in vehicle 94 of FIG. 5.

According to one embodiment of the invention, the wireless communication system(s) described herein may be implemented in emergency vehicles (e.g., fire trucks, ambulances, police cars) and utility vehicles (e.g., snow plows, garbage trucks). For example, a central network may determine the closest emergency vehicles to a reported accident or determine how to most efficiently dispatch snow plows during a snow storm. Sensors located along roadways may determine the amount of snowfall at any given location and relay the location information to central network, allowing central network to dispatch snow plows where they are most needed. The central network may also be configured to optimize timing of traffic lights to direct the emergency vehicles to their destinations quickly.

Embodiments of the wireless communication system described herein may also be implemented by repair services to speed response time when responding to a repair request. Upon receipt of a repair request, a central network may compare the request location to the locations of a network of repair vehicles to determine the closest vehicle to the request location and optimize deployment of the repair fleet. Also, central network may review the inventories of each repair vehicle to determine which vehicle is carrying the necessary parts to complete the repair request.

Alternatively, embodiments of the wireless communication system may be used by corporations to maintain a record of the location of assets (e.g., spare parts, engines, locomotives, etc.) and optimize the delivery of assets. The system may be used to improve customer relations by providing real-time tracking information for deliveries, as opposed to updating tracking information only when a delivery item passes through a pre-defined checkpoint. Also, the wireless system may be implemented in an airport to maintain records of the location of assets, such as tugs, scissor lifts for loading and unloading of baggage, and wheelchairs, for example, and optimize dispatch of an asset upon request.

Additionally, embodiments of the wireless communication system may be used to improve traffic flow. For example, wireless communication system may receive information regarding the progress of road work at different locations from the Department of Transportation. Also, wireless communication system may collect location data regarding road conditions and traffic conditions via sensors mounted on vehicles traveling through high-traffic areas, sensors located on on/off ramps, and cameras or motion sensors located along roadways. Wireless communication system may transmit road work information or traffic information to vehicles approaching the roadway and provide suggestions for alternate driving routes. Wireless communication system may also be used to eliminate toll roads by monitoring a vehicle's use of a given roadway and automatically charging a fee to the owner of the vehicle corresponding to that use. Optionally, the fee for use of the roadway may be time dependent in order to promote driving during lower-traffic time periods.

Additionally, location information and object information received by a central network of the wireless communication system may be used for comprehensive analysis of traffic patterns, driving patterns, and traffic accidents. Further, a driver or employer may request information about the driver's history, including a calculated driver safety index, driver performance index, and other driver profiling.

A technical contribution for the disclosed method and apparatus is that is provides for a computer implemented method for self-powered bi-directional wireless information transfer and information sharing within a global network of discrete objects for optimizing and tracking movement of objects.

Therefore, in accordance with one embodiment, a bi-directional wireless information system includes a plurality of sensor nodes spaced along a path of travel of an object, each of the sensor nodes corresponding to a specified location along the path of travel. The system also includes a transceiver associated with the object, the transceiver configured to communicate with the plurality of sensor nodes, such that a location of the object is determinable based on wireless communication between the transceiver and the plurality of sensor nodes. A central database included in the system is configured to receive the location of the object from at least one of the transceiver and the plurality of sensor nodes, receive object-specific data from at least one of the transceiver and the plurality of sensor nodes, and transmit location-specific data to the transceiver.

In accordance with another embodiment, a method for bi-directional wireless transmission of information between an object and a central data system includes the steps of arranging a network of wireless sensors along a pathway and associating each sensor of the network of wireless sensors with a respective position along the pathway. The method also includes the steps of wirelessly transmitting an object location to a central data system when the object moves along the pathway, the object location corresponding to the respective positions of the wireless sensors, accessing location-specific data from the central data system, the location-specific data corresponding to the object location, and wirelessly transmitting the location-specific data from the central data system to the object.

In accordance with yet another embodiment, a wireless roadway information system includes a network of sensors positioned along a roadway, each of the sensors corresponding to a specified location. The system also includes a processing unit disposed within a vehicle and comprising a transceiver configured to wirelessly communicate with the network of sensors, such that a location of the vehicle is determinable based on wireless communication between the transceiver and one of the network of sensors and a plurality of vehicle data sensors configured to acquire vehicle-specific information. The system also includes a central database located remotely from the network of sensors and the transceiver. The central database is configured to receive a wireless signal from one of the transceiver and a sensor in the network of sensors, the wireless signal including a location of the vehicle and vehicle-specific information, determine location-specific information based on the location of the vehicle, determine vehicle control commands based on the vehicle-specific information, and transmit the location-specific information and vehicle control commands to the transceiver.

This written description uses examples to disclose aspects of the invention, including the best mode, and also to enable any person skilled in the art to practice aspects of the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A bi-directional wireless information system comprising:
a plurality of sensor nodes spaced along a path of travel of an object, each of the sensor nodes corresponding to a specified location along the path of travel;
a transceiver associated with the object, the transceiver configured to communicate with the plurality of sensor nodes, such that a location of the object is determinable based on wireless communication between the transceiver and the plurality of sensor nodes; and
a central database configured to:
receive the location of the object from at least one of the transceiver and the plurality of sensor nodes;
receive object-specific data from at least one of the transceiver and the plurality of sensor nodes; and
transmit location-specific data to the transceiver.

2. The bi-directional wireless information system of claim 1 wherein the plurality of sensor nodes are further configured to relay the location-specific data to at least one of the central database and the object.

3. The bi-directional wireless information system of claim 1 wherein the plurality of sensor nodes further comprise one of RFID sensors and wireless sensors.

4. The bi-directional wireless information system of claim 1 wherein the transceiver further comprises a remote device; and
wherein the remote device is incorporated within one of a laptop computer, a PDA, a cellular phone, and a wireless handset.

5. The bi-directional wireless information system of claim 1 wherein the plurality of sensor nodes further comprise a multi-hop wireless network configured with a connectionless scheduling protocol.

6. The bi-directional wireless information system of claim 1 wherein the object further comprises one of a vehicle, a handheld wireless device, and a human being.

7. The bi-directional wireless information system of claim 1 wherein location-specific data further comprises at least one of geographical position data, weather data, traffic data, road condition data, point-of-interest data, and parking lot data.

8. The bi-directional wireless information system of claim 1 wherein object-specific data further comprises at least one of vehicle-related data and biometric driver-related data.

9. The bi-directional wireless information system of claim 8 wherein the central database is further configured to transmit vehicle control commands corresponding to the object-specific data.

10. The bi-directional wireless information system of claim 8 wherein vehicle-related data further comprises at least one of diagnostic data, inventory data, and door status data.

11. A method for bi-directional wireless transmission of information between an object and a central data system comprising the steps of:
arranging a network of wireless sensors along a pathway;
associating each sensor of the network of wireless sensors with a respective position along the pathway;
wirelessly transmitting an object location to a central data system when the object moves along the pathway, the object location corresponding to the respective positions of the wireless sensors;
accessing location-specific data from the central data system, the location-specific data corresponding to the object location; and
wirelessly transmitting the location-specific data from the central data system to the object.

12. The method of claim 11 further comprising the steps of:
wirelessly transmitting object-specific data from the object to the central data system;
generating vehicle control commands based on the object-specific data; and
wirelessly transmitting the vehicle control commands from the central data system to the object.

13. The method of claim 12 further comprising the step of wirelessly transmitting at least one of vehicle data and biometric driver data from the object to the central data system.

14. The method of claim 11 further comprising the step of wirelessly transmitting an identifier associated with one sensor of the network of sensors when the object passes the sensor on the pathway.

15. The method of claim 11 further comprising the step of wirelessly transmitting at least one of geographical position data, weather data, traffic data, point-of-interest data, and parking lot data from the central data system to the object.

16. A wireless roadway information system comprising:
a network of sensors positioned along a roadway, each of the sensors corresponding to a specified location;
a processing unit disposed within a vehicle and comprising:
a transceiver configured to wirelessly communicate with the network of sensors, such that a location of the vehicle is determinable based on wireless communication between the transceiver and one of the network of sensors; and
a plurality of vehicle data sensors configured to acquire vehicle-specific information; and
a central database located remotely from the network of sensors and the transceiver, the central database configured to:
receive a wireless signal from one of the transceiver and a sensor in the network of sensors, the wireless signal including a location of the vehicle and vehicle-specific information;
determine location-specific information based on the location of the vehicle;
determine vehicle control commands based on the vehicle-specific information; and
transmit the location-specific information and vehicle control commands to the transceiver.

17. The wireless roadway information system of claim 16 wherein the network of sensors further comprises a multi-hop wireless sensor network configured with a connectionless scheduling protocol.

18. The wireless roadway information system of claim 16 wherein the network of sensors further comprises one of RFID tags and wireless access points.

19. The wireless roadway information system of claim 16 wherein the location-specific information further comprises at least one of weather information, traffic information, point-of-interest information, and parking lot information.

20. The wireless roadway information system of claim 16 wherein vehicle-specific information further comprises at least one of vehicle diagnostic information, vehicle inventory information, and door status information.
